(19) United States
(12) Patent Application Publication
(10) Pub. No.: US 2024/0187972 A1
(43) Pub. Date: Jun. 6, 2024

(54) NF DISCOVERY BETWEEN DIFFERENT NETWORKS SUCH AS DIFFERENT SNPNs

(71) Applicant: TELEFONAKTIEBOLAGET LM ERICSSON (PUBL), Stockholm (SE)

(72) Inventors: Daniel Nilsson, Älvängen (SE); Peter Hedman, Helsingborg (SE); Chunmeng Wang, Beijing (CN)

(21) Appl. No.: 18/279,429

(22) PCT Filed: Mar. 1, 2022
(86) PCT No.: PCT/IB2022/051803

§ 371 Date: Aug. 30, 2023

Related U.S. Application Data
(60) Provisional application No. 63/156,711, filed on Mar. 4, 2021.
(60) Provisional application No. 63/156,085, filed on Mar. 3, 2021.

(51) Int. Cl. H04W 48/14; H04L 67/51; H04W 8/18

(52) U.S. Cl. CPC H04W 48/14; H04L 67/51; H04W 8/18

(57) ABSTRACT

Systems and methods are disclosed for Network Function (NF) discovery between different network such as, e.g., different Stand-alone Non-Public Networks (SNPNs). In one embodiment, a method performed by a first Network Repository Function (NRF) comprises receiving a discovery request from a NF service consumer for one or more NF profiles of one or more NF instances deployed in a separate entity, the discovery request comprising a realm or domain name of an associated User Equipment (UE). The method further comprises identifying a second NRF in a separate entity based on the realm or domain name of the associated UE and sending a discovery request to the second NRF for the one or more NF profiles of the one or more NF instances deployed in the separate entity. Corresponding embodiments of a first NRF are also disclosed.

### RELATED APPLICATIONS

This application claims the benefit of provisional patent application Ser. No. 63/156,085, filed Mar. 3, 2021 and provisional patent application Ser. No. 63/156,711, filed Mar. 4, 2021, the disclosures of which are hereby incorporated herein by reference in their entireties.

### TECHNICAL FIELD

The present disclosure relates to Network Function (NF) discovery in a cellular communication system such as, e.g., a Third Generation Partnership Project (3GPP) Fifth Generation System (5GS).

### BACKGROUND

Regarding Network Function (NF) discovery and the Node Repository Function (NRF), Third Generation Partnership Project (3GPP) Technical Specification (TS) 23.501 (see, e.g., V16.11.0), 6.3.1 states:
The NF discovery and NF service discovery enable Core Network entities (NFs or Service Communication Proxy (SCP)) to discover a set of NF instance(s) and NF service instance(s) for a specific NF service or an NF type. NF service discovery is enabled via the NF discovery procedure, as specified in TS 23.502 [3], clauses 4.17.4, 4.17.5, 4.17.9 and 4.17.10.
Unless the expected NF and NF service information is locally configured on the requester NF, e.g. when the expected NF service or NF is in the same PLMN as the requester NF, the NF and NF service discovery is implemented via the Network Repository Function (NRF). NRF is the logical function that is used to support the functionality of NF and NF service discovery and status notification as specified in clause 6.2.6.
. . .
For NF and NF service discovery across PLMNs, the NRF in the local PLMN interacts with the NRF in the remote PLMN to retrieve the NF profile(s) of the NF instance(s) in the remote PLMN that matches the discovery criteria. The NRF in the local PLMN reaches the NRF in the remote PLMN by forming a target PLMN specific query using the PLMN ID provided by the requester NF. The NF/NF service discovery procedure across PLMNs is specified in clause 4.17.5 of TS 23.502 [3].Network discovery/NRF

Regarding Standalone Non-Public Networks (SNPNs), 3GPP TS 23.501, clause 5.30.1 states:
A Non-Public Network (NPN) is a 5GS deployed for non-public use, see TS 22.261 [2]. An NPN is either:
   a Stand-alone Non-Public Network (SNPN), i.e. operated by an NPN operator and not relying on network functions provided by a PLMN, or
   a Public Network Integrated NPN (PNI-NPN), i.e. a non-public network deployed with the support of a PLMN.
   . . .
      The combination of a Public Land Mobile Network (PLMN) Identity (ID) and Network Identifier (NID) identifies an SNPN.

The SNPN is basically a normal Fifth Generation Core (5GC)/3GPP network that is deployed standalone from a PLMN/operator i.e., any industry or enterprise can deploy such a network. All that an industry or enterprise need to deploy a SNPN is a NID, which could either be self-assigned or unique via the Institute of Electrical and Electronics Engineers (IEEE). Note that these NIDs are rather cheap.

SNPNs are supported starting in 3GPP Release 16. In Release 16, the User Equipment (UE) must be configured with a subscription for that specific SNPN, and the UE will then only connect to the SNPN, at least if the UE is single subscription.

In 3GPP Release 17, support for using a subscription from a “Separate Entity” to access a SNPN is added. The Separate Entity can either be another SNPN (referred to as Home SNPN (H-SNPN)) or a PLMN. This is implemented using an architecture very similar to the existing roaming architecture where the SNPN is the Visited PLMN (V-PLMN) and the Separate Entity is the H-PLMN, as illustrated in FIG. 1. Support for this new feature raises new issues that need to be addressed.

### SUMMARY

Systems and methods are disclosed for Network Function (NF) discovery between different network such as, e.g., different Stand-alone Non-Public Networks (SNPNs). In one embodiment, a method performed by a first Network Repository Function (NRF) comprises receiving a discovery request from a NF service consumer for one or more NF profiles of one or more NF instances deployed in a separate entity, the discovery request comprising a realm or domain name of an associated User Equipment (UE). The method further comprises identifying a second NRF in a separate entity based on the realm or domain name of the associated UE and sending a discovery request to the second NRF for the one or more NF profiles of the one or more NF instances deployed in the separate entity. In this manner, NF discovery is enabled between different networks using an existing parameter that is already sent from the UE to the network.

In one embodiment, the discovery request comprises a Subscription Concealed Identifier (SUCI) of the associated UE, the SUCI of the associated UE comprises the realm or domain name of the associated UE, and identifying the second NRF in the separate entity comprises identifying the second NRF in the separate entity based on the realm or domain name of the associated UE.

In one embodiment, the discovery request comprises a Subscription Permanent Identifier (SUPI) of the associated UE, the SUPI of the associated UE comprises the realm or domain name of the associated UE, and identifying the second NRF in the separate entity comprises identifying the second NRF in the separate entity based on the realm or domain name of the associated UE.

In one embodiment, the method further comprises receiving a discovery response from the second NRF, the discovery response received from the second NRF comprising the one or more NF profiles of the one or more NF instances deployed in the separate entity. The method further comprises sending a discovery response to the NF service consumer, the discovery response sent to the NF service consumer comprising the one or more NF profiles of the one or more NF instances deployed in the separate entity.

In one embodiment, the discovery request received from the NF service consumer further comprises a Public Land Mobile Network (PLMN) Identifier (ID) of the separate entity, and identifying the second NRF comprises identifying the second NRF in the separate entity based on: (a) the realm or domain name of the associated UE and (b) the PLMN ID of the separate entity.

In one embodiment, the first NRF is in a first SNPN. In one embodiment, the separate entity is a second SNPN that is separate from the first SNPN.

In one embodiment, the discovery request sent to the second NRF comprises information that indicates that the NF service consumer is a requestor of the discovery service.

Corresponding embodiments of a first NRF are also disclosed. In one embodiment, a first NRF is adapted to receive a discovery request from NF service consumer for one or more NF profiles of one or more NF instances deployed in a separate entity, the discovery request comprising a realm or domain name of an associated UE. The first NRF is further adapted to identify a second NRF in a separate entity based on the realm or domain name of the associated UE and send a discovery request to the second NRF for the one or more NF profiles of the one or more NF instances deployed in the separate entity.

In another embodiment, a network node for implementing a first NRF comprises processing circuitry configured to cause the network node to receive a discovery request from a NF service consumer for one or more NF profiles of one or more NF instances deployed in a separate entity, the discovery request comprising a realm or domain name of an associated UE. The processing circuitry is further configured to cause the network node to identify a second NRF in a separate entity based on the realm or domain name of the associated UE and send a discovery request to the second NRF for the one or more NF profiles of the one or more NF instances deployed in the separate entity.

Embodiments of a method performed by a NF and corresponding embodiments of an NR are also disclosed. In one embodiment, a method performed by a NR comprises receiving a message from a UE, determining a realm or domain name of the UE, sending a discovery request to a first NRF for one or more NF profiles of one or more NF instances deployed in a separate entity wherein the discovery request comprises the realm or domain name of the UE, and receiving a discovery response from the first NRF.

In one embodiment, the NR is an Access and Mobility Management Function (AMF).

In one embodiment, the discovery response comprises an address of the separate entity or an address of a second NRF of the separate entity.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an architecture that supports using a subscription from a “Separate Entity” to access a Stand-alone Non-Public Network (SNPN);

FIG. 2 illustrates one example of a cellular communications system in which embodiments of the present disclosure may be implemented;

FIG. 3A illustrates one example of the cellular communications system of FIG. 2 in which the cellular communications system is a Fifth Generation System (5GS);

FIG. 3B illustrates a Network Repository Function (NRF) roaming architecture;

FIG. 4 illustrates the 5GS of FIGS. 3A and 3B using service-based interfaces between the Network Functions (NFs) in the Control Plane (CP), instead of the point-to-point reference points/interfaces used in the architecture of FIGS. 3A and 3B;

FIG. 5 illustrates the operation of a NRF in a SNPN, an NF service consumer in the SNPN, and a NRF in a Separate Entity in accordance with an embodiment of the present disclosure; and

FIGS. 6, 7, and 8 are schematic block diagrams of example embodiments of a network node in which aspects of the present disclosure may be implemented.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendices.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

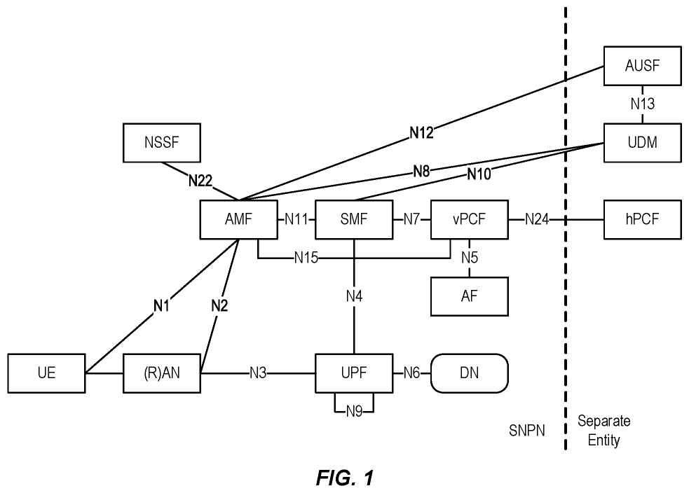

There currently exist certain challenge(s). As described above, in 3GPP Release 17, support for using a subscription from a “Separate Entity” to access a Stand-alone Non-Public Network (SNPN) is added. The Separate Entity can either be another SNPN (referred to as Home SNPN (H-SNPN)) or a Public Land Mobile Network (PLMN). This is implemented using an architecture very similar to the existing roaming architecture where the SNPN is the Visited PLMN (V-PLMN) and the Separate Entity is the Home PLMN (H-PLMN), as illustrated in FIG. 1. As with the roaming architecture of 3GPP, the architecture of FIG. 1 depends on the uniqueness of the PLMN Identity (ID) of the Separate Entity (i.e., the H-PLMN). The Network Repository Function (NRF) in the SNPN (i.e., the V-PLMN) needs to discover a Network Function(s) (NF(s)) in the Separate Entity, and the PLMN ID used by the Separate Entity is not always unique. When the Separate Entity is a SNPN, the PLMN ID is almost never unique.

Using the Network Identifier (NID) of the Separate Entity when the Separate Entity is a SNPN is being proposed in 3GPP. However, the issue with that is that the UE does not currently provide the NID of the Separate Entity to the serving SNPN. The UE only provides the NID of the serving SNPN. This means that either the UE needs to provide the NID of the Separate Entity either via N1 or via the Next Generation Radio Access Network (NG-RAN) node to the Access and Mobility Management Function (AMF) (N2). This would be equal to the UE providing the H-PLMN ID via these interfaces, and that is not done and seems to be inappropriate. Currently, the H-PLMN ID is only provided as part of the UE identity (Subscription Concealed Identifier (SUCI)/Subscription Permanent Identifier (SUPI)).

Certain aspects of the present disclosure and their embodiments may provide solutions to the aforementioned or other challenges. In one embodiment, a SNPN uses the UE identity, which is provided as SUCI or SUPI (denoted herein as “SUCI/SUPI”) to the SNPN. For SNPNs, this identity is normally a network specific identifier type of SUPI, which means that it is in NAI format (see, e.g., 3GPP TS 23.003) i.e., user@realm.

In one embodiment, the realm (i.e., from the home network ID) of the SUCI of the UE or realm (i.e., from the network specifier identifier and also called domain name) of the SUPI of the UE is used as an input parameter to a NRF in the SNPN (e.g., V-SNPN), and the NRF then uses the realm or domain name to find a NRF in the Separate Entity (e.g., H-SNPN).

There are, proposed herein, various embodiments which address one or more of the issues disclosed herein. In one embodiment, a method performed by a first NRF comprises receiving a discovery request from a NF service consumer for one or more NF profiles of one or more NF instances deployed in a separate entity, the discovery request comprising a realm or domain name of an associated UE (e.g., realm from a SUCI of the associated UE or realm/domain name (network specifier identifier) from the SUPI of the associated UE). The method further comprises identifying a second NRF in a separate entity based on the realm of the associated UE and sending a discovery request to the second NRF for the one or more NF profiles of the one or more NF instances deployed in the separate entity.

In one embodiment, the discovery request comprises a SUCI of the associated UE, the SUCI of the associated UE comprises the realm of the associated UE, and identifying the second NRF in the separate entity comprises identifying the second NRF in the separate entity based on the realm of the associated UE.

In one embodiment, the discovery request comprises a SUPI of the associated UE, the SUPI of the associated UE comprises the domain name of the associated UE, and identifying the second NRF in the separate entity comprises identifying the second NRF in the separate entity based on the domain name of the associated UE.

In one embodiment, the method further comprises receiving a discovery response from the second NRF, the discovery response received from the second NRF comprising the one or more NF profiles of the one or more NF instances deployed in the separate entity. The method further comprises sending a discovery response to the NF service consumer, the discovery response sent to the NF service consumer comprising the one or more NF profiles of the one or more NF instances deployed in the separate entity.

In one embodiment, the discovery request received from the NF service consumer further comprises a PLMN ID of the separate entity, and identifying the second NRF comprises identifying the second NRF in the separate entity based on the realm or domain name of the associated UE and the PLMN ID of the separate entity.

In one embodiment, the first NRF is in a first SNPN. In one embodiment, the separate entity is a second SNPN that is separate from the first SNPN.

In one embodiment, the discovery request sent to the second NRF comprises information that indicates that the NF service consumer is a requestor of the discovery service.

Corresponding embodiments of the first NRF and a network node that implements the first NRF are also disclosed herein.

Certain embodiments may provide one or more of the following technical advantage(s). For embodiments of the present disclosure, there is no need to add parameters from the UE. Instead, the existing parameter (SUCI/SUPI) that is already sent from UE to AMF can be re-used.

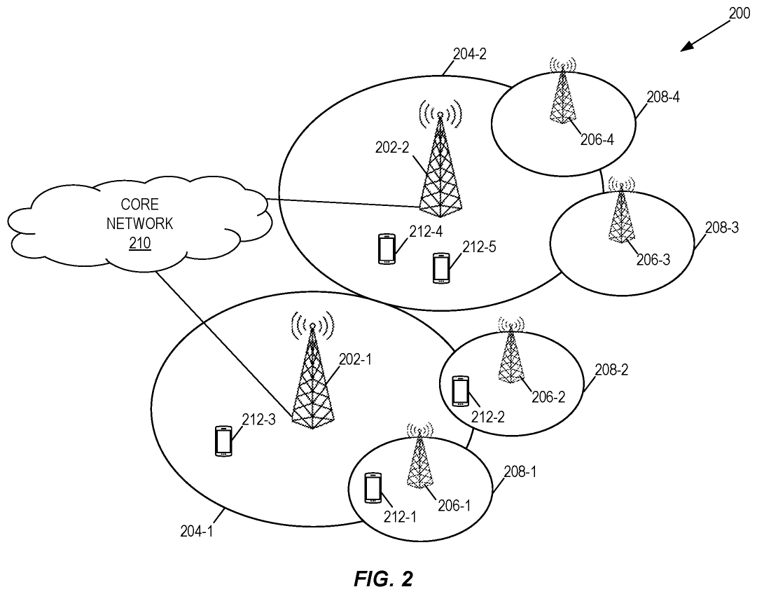

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC); however, the embodiments disclosed herein are not limited to the 5GS and may be implemented in any similar type of cellular or wireless communication system. In this example, the RAN includes base stations 202-1 and 202-2, which in the NG-RAN include NR base stations (gNBs) and optionally next generation eNBs (ng-eNBs), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs and as such sometimes referred to herein as UEs 212, but the present disclosure is not limited thereto.

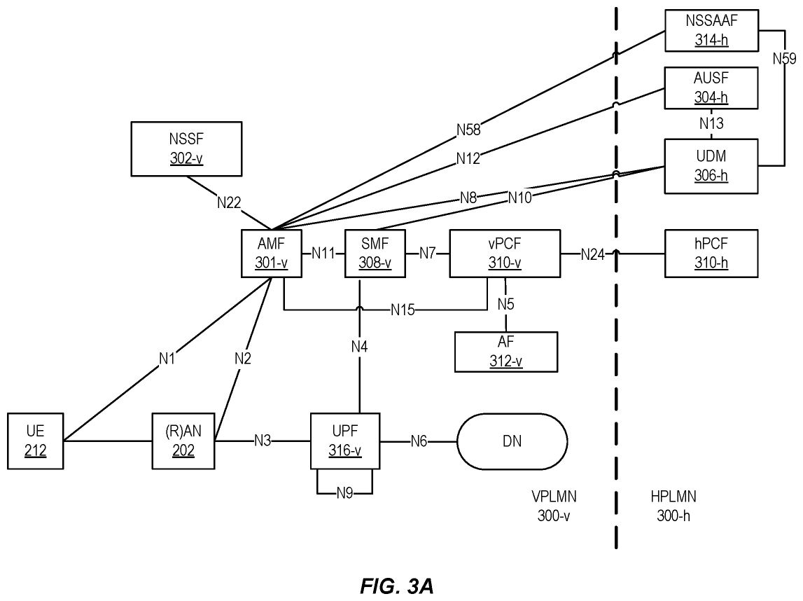

FIG. 3A illustrates one example of the cellular communications system 200 in which the cellular communications system 200 is a 5GS. In this example, the 5GS is more specifically a 5GS in accordance with the roaming 5GS architecture for the local break-out scenario in reference point representation. However, a similar 5GS architecture for the home routed scenario may alternatively be used. In FIG. 3A, the core network 210 is composed of core Network Functions (NFs), where interaction between any two NFs is represented by a point-to-point reference point/interface.

The 5GS includes a Visited Public Land Mobile Network (V-PLMN) 300-v and a Home Public Land Mobile Network (H-PLMN) 300-h. In some of the embodiments described herein, the V-PLMN 300-v is a Standalone Non-Public Network (SNPN), and the H-PLMN 300-h is a Separate Entity. Seen from the access side, the 5G network architecture shown in FIG. 3 comprises a plurality of UEs 212 connected to either a RAN 202 or an Access Network (AN) as well as an AMF 301-v. Note that “v” and “h” are utilized in the reference numbers to indicate whether the NF is in the V-PLMN 300-v or the H-PLMN 300-h. Typically, the R(AN) 202 comprises base stations, e.g. such as eNBs or gNBs or similar. Seen from the core network side, the 5GC NFs shown in FIG. 3 include a NSSF 302-v, an AUSF 304-h, a UDM 306-h, the AMF 301-v, a SMF 308-v, a visited PCF 310-v, a home PCF 310-h, an Application Function (AF) 312-v, and a Network Slice-Specific Authentication and Authorization Function (NSSAAF) 314-h. Reference point representations of the 5G network architecture are used to develop detailed call flows in the normative standardization.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

FIG. 3B illustrates the NRF roaming architecture. As illustrated, the core network 210 further includes a visited NRF 318-v and a home NRF 318-h. V-PLMN NF 320-v-v can be any NF in the V-PLMN 300-v that interacts with the visited NRF 318-v.

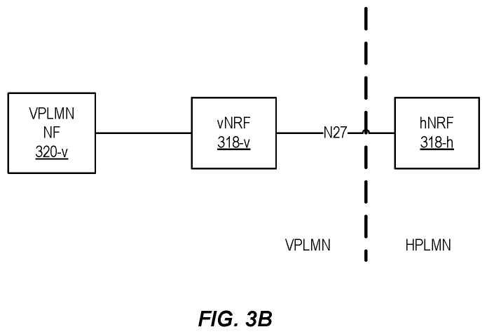

FIG. 4 illustrates the 5GS of FIGS. 3A and 3B using service-based interfaces between the NFs in the CP, instead of the point-to-point reference points/interfaces used in the 5G network architecture of FIGS. 3A and 3B. The NFS described above with reference to FIGS. 3A and 3B correspond to the NFs shown in FIG. 4. The service(s) etc. that a NF provides to other authorized NFs can be exposed to the authorized NFs through the service-based interface. In FIG. 4, the service based interfaces are indicated by the letter “N” followed by the name of the NF, e.g. Namf for the service based interface of the AMF 301-v, and Nsmf for the service based interface of the SMF 308-v, etc. The NEF 400-v and 400-h and Security Edge Protection Proxies (SEPPs) 400-v and 400-h in FIG. 4 are not shown in FIGS. 3A and 3B discussed above.

An NF may be implemented either as a network element on a dedicated hardware, as a software instance running on a dedicated hardware, or as a virtualized function instantiated on an appropriate platform, e.g., a cloud infrastructure.

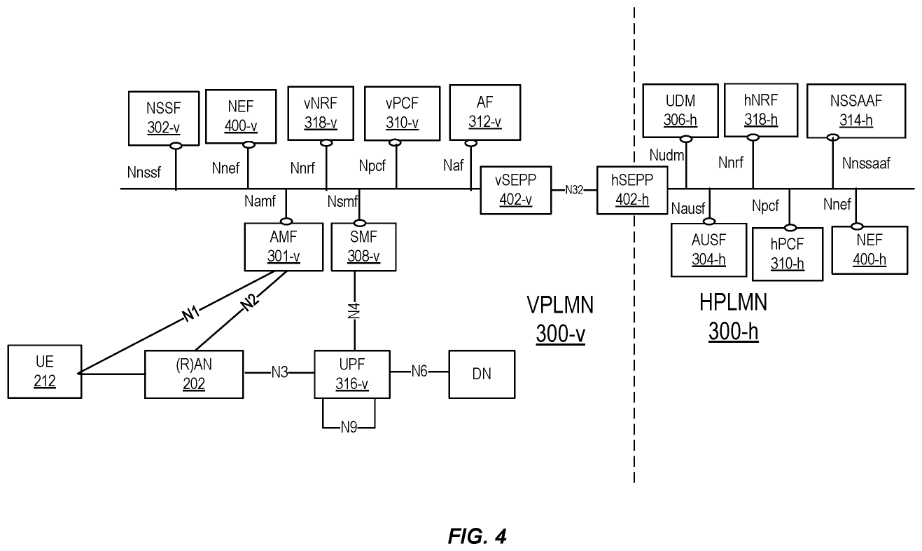

FIG. 5 illustrates the operation of a NRF in a SNPN, an NF service consumer in the SNPN, and a NRF in a Separate Entity in accordance with an embodiment of the present disclosure. In the example architectures described above, the NRF in the SNPN is the vNRF 318-v, the NF service consumer in the SNPN is the V-PLMN NF 320-v, and the NRF in the Separate Entity is the hNRF 318-h. As such, the corresponding reference numbers are used here.

In the case that the NF service consumer intends to discover the NF/NF service in Separate Entity (H-SNPN), the NRF in SNPN needs to request “NF Discovery” service from NRF in the Separate Entity (H-SNPN). The procedure is depicted in FIG. 5.

Step 500: The NF service consumer 320-v in the SNPN invokes Nnrf_NFDiscovery_Request to an appropriately configured NRF 318-v in the SNPN. The Nnrf_NFDiscovery_Request includes a realm or domain name of an associated UE 212 and optionally PLMN ID of the Separate Entity. In one particular embodiment, the Nnrf_NFDiscovery_Request includes the following parameters: Expected Service Name, NF type of the expected NF, realm (and optionally PLMN ID), SNPN PLMN ID+NID, NF type of the NF service consumer. As discussed above, the realm/domain name is part of a SUCI/SUPI of the UE 212. More specifically, in one embodiment, the Nnrf_NFDiscovery_Request includes the SUCI of the associated UE 212, where the SUCI includes the realm of the associated UE 212. In another embodiment, the Nnrf_NFDiscovery_Request includes the SUPI of the associated UE 212, where the SUPI includes the network specific identifier which includes the domain name of the associated UE 212. Thus, the SUPI is referred to herein as including the domain name of the associated UE 212. The request may also optionally include producer NF Set ID, NF Service Set ID, S-NSSAI, NSI ID if available, and other service-related parameters. A complete list of parameters is provided in service definition in clause 5.2.7.3.2 of 3GPP TS 23.502. The Nnrf_NFDiscovery_Request requests an expected NF profile(s) for a NF instance(s) deployed in the Separate Entity.

NOTE 1: The use of NSI ID within a PLMN depends on the network deployment.

Step 502: The NRF 318-v in SNPN identifies the NRF 318-h in Separate Entity (H-SNPN) (hNRF) based on the realm or domain name (and optionally PLMN ID), and the NRF 318-v requests “NF Discovery” service from the NRF 318-h in the Separate Entity (H-SNPN), e.g., according to the procedure in FIG. 4.17.4-1 of 3GPP TS 23.501 to get the expected NF profile(s) of the NF instance(s) deployed in the Separate Entity (H-SNPN). As the NRF 318-v in the SNPN triggers the “NF Discovery” on behalf of the NF service consumer 320-v, the NRF 318-v in the SNPN does not replace the information of the service requester NF, i.e. NF consumer ID, in the Discovery Request message it sends to the hNRF 318-h.

The hNRF 318-h may further query an appropriate local NRF in the Separate Entity (H-SNPN) based on the input information received from the NRF 318-v of the SNPN. The Fully Qualified Domain Name (FQDN) of the local NRF or Endpoint Address of the local NRF's NF Discovery service in the Separate Entity (H-SNPN) may be configured in the hNRF 318-h or may need to be discovered based on the input information.

Step 504: The NRF 318-v in SNPN provides a Nnrf_NFDiscovery_Response to the NF service consumer 320-v. This response may be, e.g., the same as step 3 in clause 4.17.4 of 3GPP TS 23.502. This response includes the expected NF profile(s) of the NF instance(s) deployed in the Separate Entity.

Note that the above procedure is a described as a modified version of the procedure in 3GPP TS 23.502 clause 4.17.5, which is for the roaming scenario between PLMNs. This will be very similar to this scenario but the home PLMN ID needs to be changed to the realm in SUCI/SUPI. Note that other parts have changed as well (e.g., HPLMN->Separate Entity and serving PLMN->SNPN).

While not illustrated, in another embodiment, a procedure for NF discovery includes the following steps:
A NF (e.g., the NF service consumer 320-v such as, e.g., an AMF) receives a message from a UE 212;
The NF determines a realm or domain name of the UE 212 (e.g., from a SUCI or SUPI included in the received message);
The NF sends a discovery request to the vNRF 318-v for one or more NF profiles of one or more NF instances deployed in a separate entity (e.g., hSNPN), the discovery request comprising the realm or domain name of the UE 212.
The vNRF 318-v identifies the separate entity (e.g., an address of the separate entity) or the hNRF 318-h in the separate entity (e.g., an address of the hNRF 318-h in the separate entity), based on the realm or domain name of the UE 212.
The vNRF 318-v sends a discovery response to the NF (and the NF receives the discovery response). In one embodiment, the discovery response identifies the separate entity (e.g., includes an address of the separate entity). In another embodiment, the discovery response identifies the hNRF 318-h (e.g., includes an address of the hNRF 318-h.
The NF may then send the discovery request for the one or more NF profiles of one or more NF instances deployed in the separate entity to the hNRF 318-h, for example. Alternatively, the vNRF 318-v may send the discovery request to the hNRF 318-h and send the resulting discovery response to the NF in a manner similar to what is described above with respect to FIG. 5.

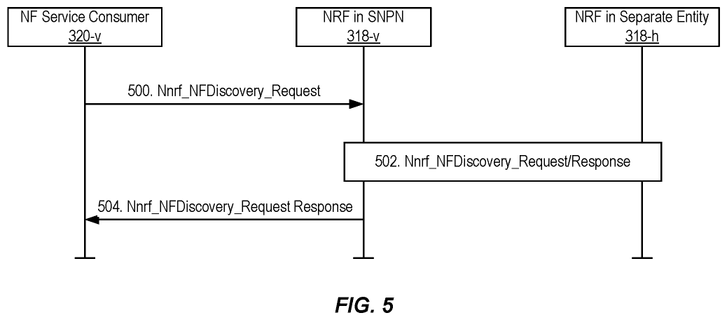

FIG. 6 is a schematic block diagram of a network node 600 according to some embodiments of the present disclosure. Optional features are represented by dashed boxes. The network node 600 may be, for example, a network node that implements all or part of the functionality of a core NF such as, e.g., the vNRF 318-v, the hNRF 318-h, or the V-PLMN NF 320-v as described above, e.g., with respect to FIG. 5. As illustrated, the network node 600 includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. The one or more processors 604 operate to provide one or more functions of the network node 600 as described herein (e.g., all or part of the functionality of a core NF such as, e.g., the vNRF 318-v, the hNRF 318-h, or the V-PLMN NF 320-v as described above). In some embodiments, the function(s) are implemented in software that is stored, e.g., in the memory 606 and executed by the one or more processors 604.

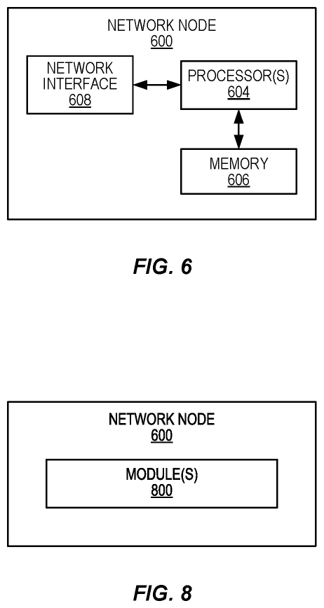

FIG. 7 is a schematic block diagram that illustrates a virtualized embodiment of the network node 600 according to some embodiments of the present disclosure. Again, optional features are represented by dashed boxes. As used herein, a “virtualized” network node is an implementation of the network node 600 in which at least a portion of the functionality of the network node 600 is implemented as a virtual component(s) (e.g., via a virtual machine(s) executing on a physical processing node(s) in a network(s)). As illustrated, in this example, the network node 600 includes one or more processing nodes 700 coupled to or included as part of a network(s) 702. Each processing node 700 includes one or more processors 704 (e.g., CPUs, ASICS, FPGAS, and/or the like), memory 706, and a network interface 708. In this example, functions 710 of the network node 600 described herein (e.g., all or part of the functionality of a core NF such as, e.g., the vNRF 318-v, the hNRF 318-h, or the V-PLMN NF 320-v as described above) are implemented at the one or more processing nodes 700 or distributed across two or more of the processing nodes 700 in any desired manner. In some particular embodiments, some or all of the functions 710 of the network node 600 described herein are implemented as virtual components executed by one or more virtual machines implemented in a virtual environment(s) hosted by the processing node(s) 700.

In some embodiments, a computer program including instructions which, when executed by at least one processor, causes the at least one processor to carry out the functionality of the network node 600 or a node (e.g., a processing node 700) implementing one or more of the functions 710 of the network node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

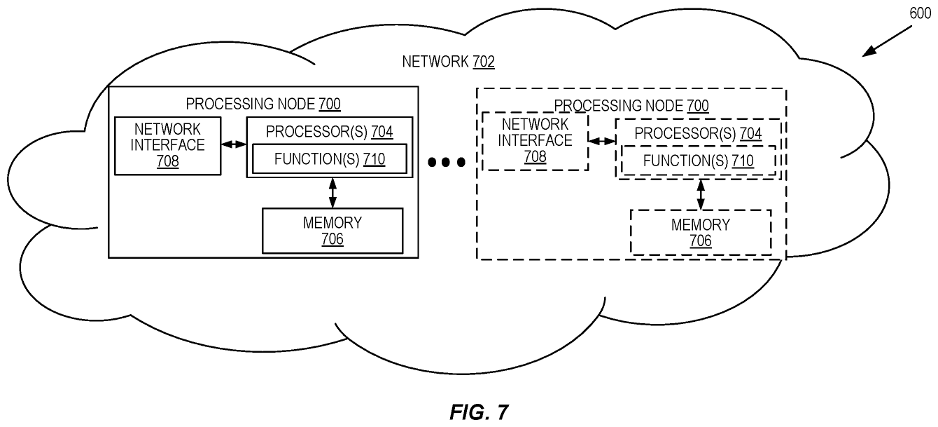

FIG. 8 is a schematic block diagram of the network node 600 according to some other embodiments of the present disclosure. The network node 600 includes one or more modules 800, each of which is implemented in software. The module(s) 800 provide the functionality of the network node 600 described herein (e.g., all or part of the functionality of a core NF such as, e.g., the vNRF 318-v, the hNRF 318-h, or the V-PLMN NF 320-v as described above). This discussion is equally applicable to the processing node 700 of FIG. 7 where the modules 800 may be implemented at one of the processing nodes 700 or distributed across multiple processing nodes 700.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a first Network Repository Function, NRF, the method comprising:
receiving a discovery request from a Network Function, NF, service consumer for one or more NF profiles of one or more NF instances deployed in a separate entity, the discovery request comprising a realm or domain name of an associated User Equipment, UE;
identifying a second NRF in the separate entity based on the realm or domain name of an identifier of the associated UE; and
sending a discovery request to the second NRF for the one or more NF profiles of the one or more NF instances deployed in the separate entity,
wherein the first NRF is in a first Standalone Non-Public Network, SNPN.

2. The method of claim 1 wherein the discovery request comprises a Subscription Concealed Identifier, SUCI, of the associated UE, the SUCI of the associated UE comprises the realm or domain name of the associated UE, and identifying the second NRF in the separate entity comprises identifying the second NRF in the separate entity based on the realm or domain name of the associated UE.

3. The method of claim 1 wherein the discovery request comprises a Subscription Permanent Identifier, SUPI, of the associated UE, the SUPI of the associated UE comprises the realm or domain name of the associated UE, and identifying the second NRF in the separate entity comprises identifying the second NRF in the separate entity based on the realm or domain name of the associated UE.

4. The method of claim 1 further comprising:
receiving a discovery response from the second NRF, the discovery response received from the second NRF comprising the one or more NF profiles of the one or more NF instances deployed in the separate entity; and
sending a discovery response to the NF service consumer, the discovery response sent to the NF service consumer comprising the one or more NF profiles of the one or more NF instances deployed in the separate entity.

5. The method of claim 1 wherein the discovery request received from the NF service consumer further comprises a Public Land Mobile Network, PLMN, Identifier, ID, of the separate entity, and identifying the second NRF comprises identifying the second NRF in the separate entity based on: (a) the realm or domain name of the associated UE and (b) the PLMN ID of the separate entity.

6. (canceled)

7. The method of claim 1 wherein the separate entity is a second SNPN that is separate from the first SNPN.

8. The method of claim 1 wherein the discovery request sent to the second NRF comprises information that indicates that the NF service consumer is a requestor of the discovery service.

9. (canceled)

10. (canceled)

11. A network node for implementing a first Network Repository Function, NRF, the network node comprising:
processing circuitry configured to cause the network node to:
receive a discovery request from a Network Function, NF, service consumer for one or more NF profiles of one or more NF instances deployed in a separate entity, the discovery request comprising a realm or domain name of an associated User Equipment, UE;
identify a second NRF in a separate entity based on the realm or domain name of an identifier of the associated UE; and
send a discovery request to the second NRF for the one or more NF profiles of the one or more NF instances deployed in the separate entity,
wherein the first NRF is in a first Standalone Non-Public Network, SNPN.

12. The network node of claim 11 wherein:
the discovery request comprises a Subscription Concealed Identifier, SUCI, of the associated UE;
the SUCI of the associated UE comprises the realm or domain name of the associated UE; and
in order to identify the second NRF in the separate entity, the processing circuitry is further configured to cause the network node to identify the second NRF in the separate entity based on the realm or domain name of the associated UE.

13. The network node of claim 11 wherein:
the discovery request comprises a Subscription Permanent Identifier, SUPI, of the associated UE;
the SUPI of the associated UE comprises the realm or domain name of the associated UE; and
in order to identify the second NRF in the separate entity, the processing circuitry is further configured to cause the network node to identify the second NRF in the separate entity based on the realm or domain name of the associated UE.

14. The network node of claim 11 wherein the processing circuitry is further configured to cause the network node to:
receive a discovery response from the second NRF, the discovery response received from the second NRF comprising the one or more NF profiles of the one or more NF instances deployed in the separate entity; and
send a discovery response to the NF service consumer, the discovery response sent to the NF service consumer comprising the one or more NF profiles of the one or more NF instances deployed in the separate entity.

15. The network node of claim 11 wherein:
the discovery request received from the NF service consumer further comprises a Public Land Mobile Network, PLMN, Identifier, ID, of the separate entity; and
in order to identify the second NRF, the processing circuitry is further configured to cause the network node to identify the second NRF in the separate entity based on: (a) the realm or domain name of the associated UE and (b) the PLMN ID of the separate entity.

16. (canceled)

17. The network node of claim 11 wherein the separate entity is a second SNPN that is separate from the first SNPN.

18. The network node of claim 11 wherein the discovery request sent to the second NRF comprises information that indicates that the NF service consumer is a requestor of the discovery service.

19. A method performed by a Network Function, NF, the method comprising:
receiving a message from a User Equipment, UE;
determining a realm or domain name of the UE;
sending a discovery request to a first Network Repository Function, NRF, for one or more NF profiles of one or more NF instances deployed in a separate entity, the discovery request comprising the realm or domain name of the UE;
receiving a discovery response from the first NRF.

20. The method of claim 19, wherein the NF is an AMF.

21. The method of claim 19, wherein the discovery response comprises an address of the separate entity or an address of a second NRF of the separate entity.
